(19) United States
(12) Patent Application Publication
(10) Pub. No.: US 2003/0216173 A1
(43) Pub. Date: Nov. 20, 2003

(54) Gaming machine having separate touch screen for player input

(75) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(73) Assignee: Atronic International GmbH

(21) Appl. No.: 10/354,557

(22) Filed: Jan. 29, 2003

Related U.S. Application Data
(63) Continuation-in-part of application No. 10/146,565, filed on May 14, 2002.

(51) Int. Cl. A63F 13/00

(52) U.S. Cl. 463/30

(57) ABSTRACT

In one embodiment, a gaming machine includes a separate touch screen located in an area where buttons are typically located. The touch screen virtual buttons may be both configurable by the player and configurable by the gaming machine. A joystick may also be provided on the gaming machine. In one embodiment, the player is given extra credits by the gaming machine if large denomination currency is inserted into the gaming machine.

### CROSS-REFERENCE TO RELATED APPLICATIONS

This application is a continuation-in-part of U.S. application Ser. No. 10/146,565, filed May 14, 2002.

### FIELD OF INVENTION

This invention relates to gaming machines and, in particular, to player control devices in gaming machines.

### BACKGROUND

A typical gaming machine found in casinos uses physical buttons to receive player inputs, such as to spin reels, bet, and cash out. Some video gaming machines use a touch screen as the main video screen to allow the player to make selections by touching virtual buttons (or other icons) on the touch screen.

### SUMMARY

In one embodiment, a gaming machine includes a main display and a separate touch screen located in an area where buttons are typically located. The touch screen has virtual buttons that may be both configurable by the player and configurable by the gaming machine. For example, the player can locate the virtual buttons on the right or left side of the touch screen, change the size of the virtual buttons, delete virtual buttons not being used, select a language identifying the buttons, or select sounds when touching the buttons. The machine's computer can change the display on the touch screen to display the acceptable denominations of the machine or select a different set of virtual buttons depending on the game being played. Many more options are available. Many options can be provided to the player on the touch screen, as compared to physical buttons, since all options do not have to be present at all times.

In one embodiment, a joystick is provided on the gaming machine to enable the player to perform game control functions that would normally be difficult using conventional gaming machine controllers.

In one embodiment, the player is given extra credits by the gaming machine if large denomination currency is inserted into the gaming machine. This typically results in longer playing times.

### BRIEF DESCRIPTION OF THE DRAWINGS

The below described drawings are presented to illustrate some possible examples of the invention.

FIG. 1 is a perspective view of one example of a gaming machine incorporating a joystick.

FIG. 2 is a perspective view of one example of a gaming machine incorporating a separate touch screen for player inputs.

FIGS. 3, 4, 5, and 6 illustrate touch screen displays showing the flexibility of using a touch screen for player inputs.

FIG. 7 is a block diagram of various key components in a gaming machine.

### DETAILED DESCRIPTION

Although the invention can be implemented by modifying most types of modern gaming machines, one particular gaming machine platform will be described in detail.

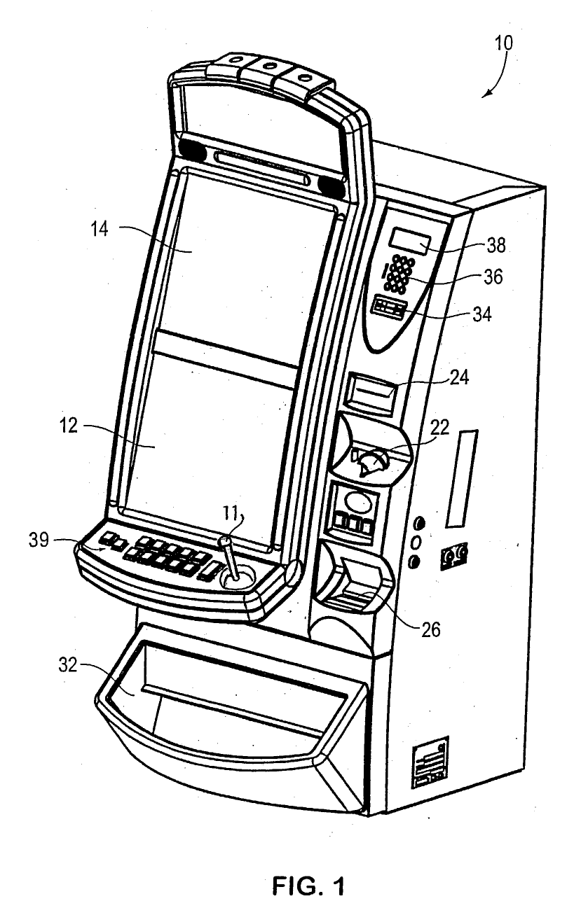

FIG. 1 is a perspective view of a gaming machine 10 that incorporates a joystick 11 in accordance with one embodiment of the present invention. Machine 10 includes a display 12 that may be a thin film transistor (TFT) display, a liquid crystal display (LCD), a cathode ray tube (CRT), or any other type of display. A second display 14 provides game data or other information in addition to display 12. Display 14 may provide static information, such as an advertisement for the game, the rules of the game, pay tables, paylines, or other information, or may even display the game itself along with display 12. Alternatively, the area for display 14 may be a display glass for conveying information about the game.

A coin slot 22 accepts coins or tokens in one or more denominations to generate credits within machine 10 for playing games. An input slot 24 for an optical reader and printer receives machine readable printed tickets and outputs printed tickets for use in cashless gaming. A bill acceptor 26 accepts various denominations of banknotes.

A coin tray 32 receives coins or tokens from a hopper upon a win or upon the player cashing out.

A card reader slot 34 accepts any of various types of cards, such as smart cards, magnetic strip cards, or other types of cards conveying machine readable information. The card reader reads the inserted card for player and credit information for cashless gaming. The card reader may also include an optical reader and printer for reading and printing coded barcodes and other information on a paper ticket.

A keypad 36 accepts player input, such as a personal identification number (PIN) or any other player information. A display 38 above keypad 36 displays a menu for instructions and other information and provides visual feedback of the keys pressed.

Player control buttons 39 include any buttons needed for the play of the particular game or games offered by machine 10 including, for example, a bet button, a repeat bet button, a play two-ways button, a spin reels button, a deal button, hold cards buttons, a draw button, a maximum bet button, a cash-out button, a display paylines button, a display payout tables button, select icon buttons, and any other suitable button. In other embodiments (described later), buttons 39 are replaced by a touch screen with virtual buttons.

The game played may be a spinning reel type game, either using physical reels or simulated reels on a video screen, or the game may be a card game, such as poker. Any other game may be played.

Joystick 11 may be used to control a cursor or other object displayed on display 12 or 14. A cursor may be used to select an icon or other option displayed. In certain games, such as a maze type game, joystick 11 may be used to control the direction of a character or other object through the maze. Such a game may be a bonus game played after a certain outcome of a main game, such as after a certain symbol combination in the main game. Joystick 11 and software for converting the joystick 11 movement to usable signals for the gaming machine's CPU may be conventional.

Buttons 39 may be deleted and joystick 11 may be used for all player inputs. In one embodiment, joystick 11 has a select button at its tip. The select button may be the round knob at the end of joystick 11 in FIG. 1. The button is pressed to make a player selection. In another embodiment, pushing down on joystick 11 controls a switch to make the player selection.

Joystick 11 may be centrally located so as not to favor left-handed or right-handed players. The joystick may take different forms, such as a wider form to enable the player to use her palm to move the joystick.

Joystick 11 may also be replaced with a trackball to achieve similar results.

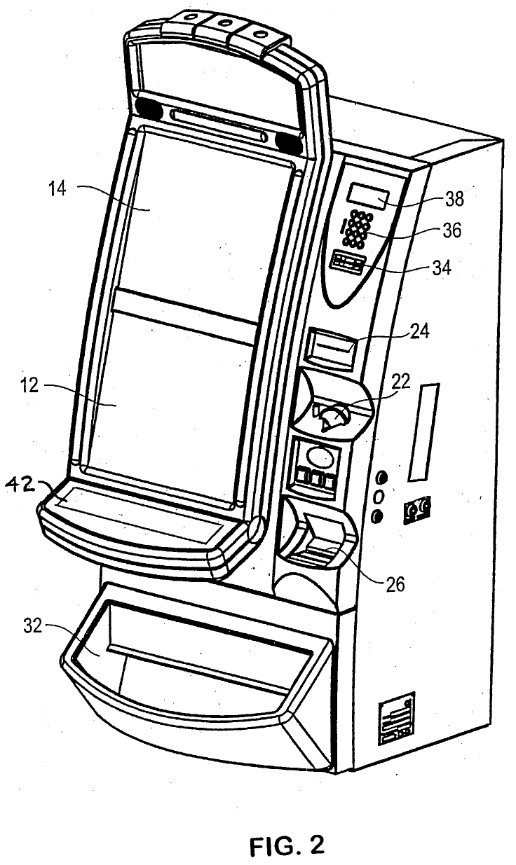

FIG. 2 illustrates the gaming machine of FIG. 1 but with buttons 39 replaced by a touch screen 42. Touch screen 42 may be a conventional type, such as a touch-sensitive overlay on a TFT, LCD, CRT, or other display device. The overlay may detect a change in capacitance at X-Y coordinates by the player touching a position on the touch screen. Conventional circuits detect the touched X-Y position and associate the position with a function to be carried out. Any appropriate virtual buttons for player input may be displayed on touch screen 42, where actuation of any virtual button is by touching the virtual button. Touch screen 42 is conveniently located on an angled shelf and does not take up any of the main display 12 screen area. Accordingly, the game's display program is not affected by changes to the touch screen 42 display, and the entire main display 12 may be used for the game. Providing a touch screen 42 for player input provides many advantages, some of which are described below.

Conventional gaming machines that display virtual buttons on the vertical main display require the player to tilt her hand upward to touch the screen with the pad of her fingertip. This is especially inconvenient if the player has long fingernails. By providing the virtual buttons on an angled shelf, the player can simply rest her hands on the shelf while touching the virtual buttons.

Joystick 11 of FIG. 1 can be used in combination with touch screen 42. Any combination of joystick 11, buttons 39, and touch screen 42 can be used in the gaming machine.

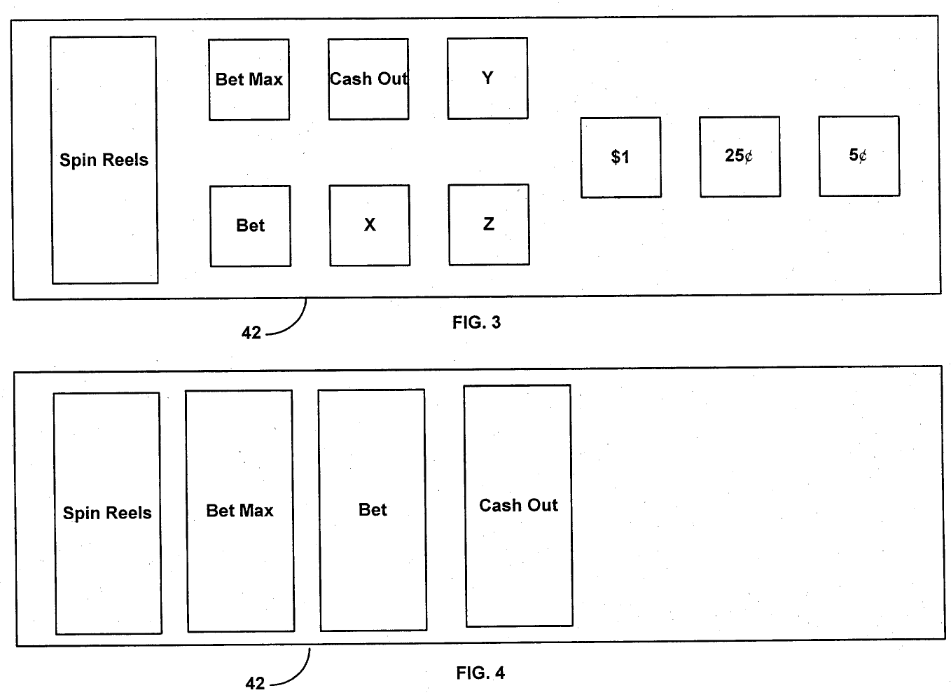

FIG. 3 illustrates a possible display on touch screen 42. The display is for a conventional spinning reels type game, either on a video screen or using motor-driven reels. The basic virtual buttons include spin reels, bet max, bet one, and cash-out. Other buttons that may be used are generally designated X, Y, and Z. The player may touch any of the virtual buttons to perform its function. Also included are denomination virtual buttons for $1, 25¢, and 5¢. The player may touch a denomination button to select the value of a single credit. This affects the amount bet and the amount won during each game. To encourage players to select a high denomination credit value, the machine's processing circuitry may give the player extra credits (greater than the monetary value inserted into the machine) for selecting a high denomination credit value. In one embodiment, generating such extra credits are contingent upon the player inserting a high value bill into the machine.

In one embodiment, the player is given extra credits by inserting high value currency into the machine. Such a “discount” may be advertised on the display monitor, the display glass, or touch screen 42 to encourage players to insert high value currency. Examples of discounts may be 6% extra credits for inserting $100, 5% extra credits for inserting $20, etc. To prevent players from immediately cashing out of the machine, the discount may only apply if the player eventually wagers all of the credits on the game (e.g., for a $1 machine, the player must ultimately wager the 106 credits from the $100 bill in order to get the 6 extra credits). Other techniques may also be used to prevent the player from prematurely cashing out.

Some advantages of touch screen 42 include:

Player can select the language identifying the buttons and the language for any displayed messages;

Player can select which buttons to be displayed;

Player can select the location of the individual buttons for ease of touching;

Player can select the color, size, and shape of the buttons;

Machine can display only those buttons that are immediately of use to the player, thus simplifying the display;

Machine can highlight buttons (e.g., make brighter) that are appropriate to touch;

Machine may change the buttons for different games to be played;

Machine may present advertising or other messages on touch screen 42 (in the language selected by the player), such as how to use touch screen 42 to control the various button options;

Machine may display an elaborate player controller when appropriate, such as arrows for controlling a character through a maze.

FIG. 4 illustrates another display on touch screen 42. The player may initially be presented with a default screen and be asked to choose certain options by touching an icon associated with the desired option. One option may be to only display essential virtual buttons, such as spin reels, bet max, bet one, and cash out. Messages or an advertisement may be displayed in the unused area. Using a menu driven display, the above-described options may be simply presented to the player for selection. The button-set options for touch screen 42 may be presented on touch screen 42 or on the main display 12.

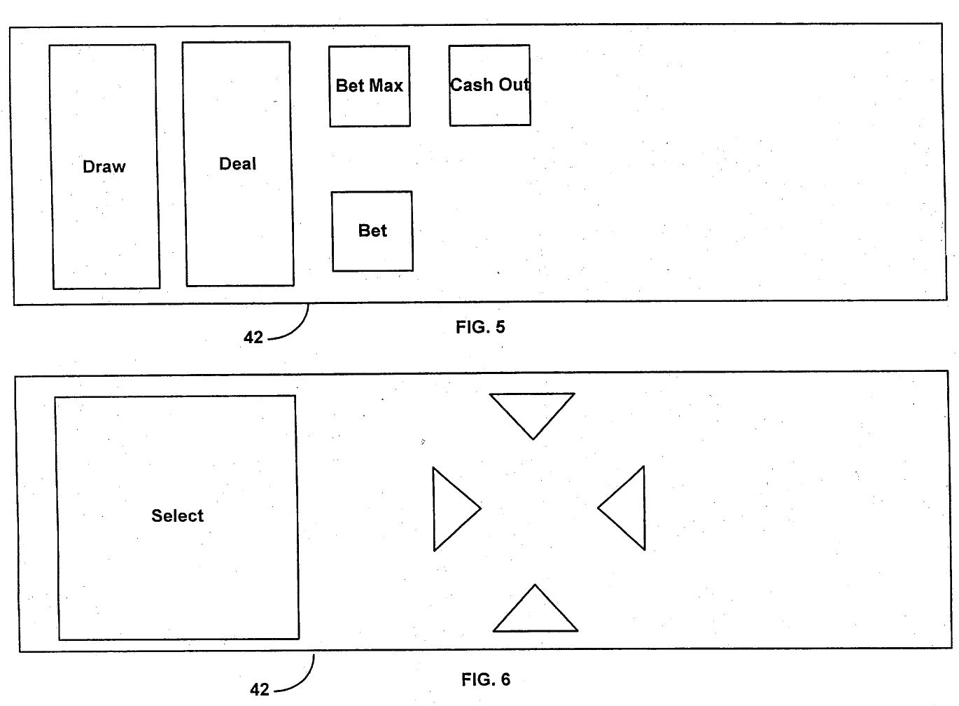

FIG. 5 illustrates touch screen 42 displaying an entirely new set of buttons in response to the player choosing to play a poker game rather than a spinning reels type game.

FIG. 6 illustrates touch screen 42 displaying buttons as a result of the player achieving a bonus outcome in the main game and the machine now allowing the player to play a bonus game for an additional award. The bonus game may be a maze type of game, previously described, or any other game.

Touch screen 42 is also useful for simplifying the selection of paylines and bet per line of different games played on the same machine. For example, one game selected by the player may be a basic 3-payline game, while the next player may select to play a 15-payline game. The options provided by touch screen 42 would change for different games to not give inapplicable options to the player.

As seen, anything can be displayed on touch screen 42, resulting in a very flexible and desirable gaming machine for both the players and the casino. By enabling the machine to be easily configurable for different currencies and games by a software change, costs are saved by not having to replace the machine.

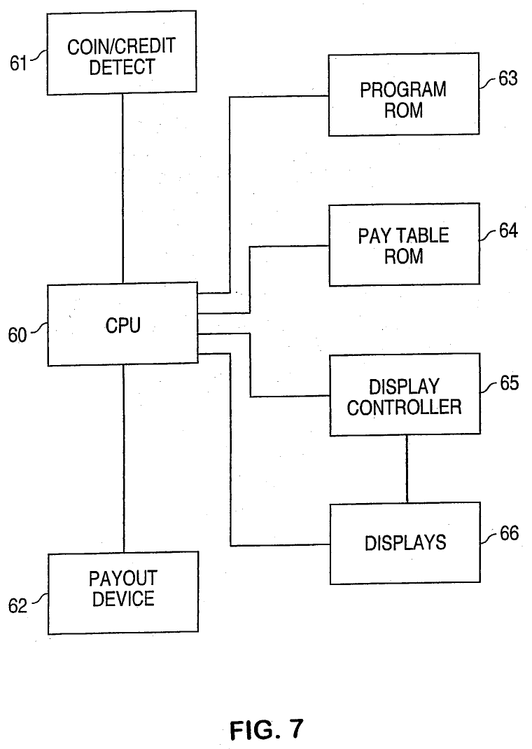

FIG. 7 illustrates basic circuit blocks in a suitable gaming device. A control unit (CPU 60) runs a gaming program stored in a program ROM 63. A coin/bill/credit detector 61 enables the CPU 60 to initiate a next game. A pay table ROM 64 detects the outcome of the game and identifies awards to be paid to the player. A payout device 62 pays out an award to the player in the form of coins upon termination of the game or upon the player cashing out. The payout device 62 may instead generate a payout in the form of a coded paper ticket, credits on a smart card or magnetic strip card, or in any other form. A display controller 65 receives commands from the CPU 60 and generates signals for the various displays 66, including touch screen 42. Player commands may be input through the touch screen(s) into the CPU 60.

While particular embodiments of the present invention have been shown and described, it will be obvious to those skill in the art that changes and modifications may be made without departing from this invention in its broader aspects and, therefore, the appended claims are to encompass within their scope all changes and modifications that fall within the true spirit and scope of the invention.

What is claimed is:

1. A gaming device comprising:
at least one processor, the at least one processor comprising a processor programmed to carry out a game on a main display;
a main display for displaying the game; and
a touch screen, separate from the main display, for displaying player input icons for controlling the game and for generating signals upon the player touching displayed icons to control the game.

2. The device of claim 1 wherein the main display is a video screen.

3. The device of claim 1 wherein the main display displays motor-driven reels.

4. The device of claim 1 wherein the player input icons comprise virtual buttons.

5. The device of claim 1 wherein the at least one processor is programmed for allowing the player to select which icons to display on the touch screen.

6. The device of claim 1 wherein the at least one processor is programmed for allowing the player to select the location on the touch screen of at least one virtual button.

7. The device of claim 1 wherein the at least one processor is programmed for allowing the player to select a size of virtual buttons to display on the touch screen.

8. The device of claim 1 wherein the at least one processor is programmed for allowing the player to select a language identifying virtual buttons displayed on the touch screen.

9. The device of claim 1 wherein the at least one processor is programmed to change identities of virtual buttons displayed on the touch screen.

10. The device of claim 1 wherein the at least one processor is programmed to change identities of virtual buttons displayed on the touch screen to only display buttons that a player can use for a present game.

11. The device of claim 1 wherein the at least one processor is programmed to highlight certain virtual buttons displayed on the touch screen.

12. The device of claim 1 wherein the at least one processor is programmed to display a message on the touch screen to convey information about modifying virtual buttons displayed on the touch screen.

13. The device of claim 1 further comprising a payout device for granting an award to a player for a winning outcome of the game.

14. The device of claim 1 where the icons comprise a bet virtual button and a cash out virtual button.

15. The device of claim 1 further comprising a joystick for allowing the player to control aspects of the game.

16. The device of claim 1 further comprising physical buttons for allowing the player to control aspects of the game.

17. The device of claim 1 wherein the touch screen displays messages to the player.

18. The device of claim 17 wherein the messages comprise advertisements.

19. The device of claim 17 wherein the messages comprise instructions.

20. A gaming device comprising:
at least one processor, the at least one processor comprising a processor programmed to carry out a game on a main display;
a main display for displaying the game;
a joystick for enabling a player to control an aspect of the game; and
a payout device for granting an award to a player for a winning outcome of the game.

21. The device of claim 20 wherein the joystick comprises an actuator to enable the player to make a selection by controlling the actuator.

22. The device of claim 21 wherein the actuator is pressed to make a selection.

23. The device of claim 21 wherein the actuator is a button on the joystick.

24. The device of claim 20 further comprising physical buttons for allowing the player to control aspects of the game.

25. The device of claim 20 further comprising a touch screen, separate from the main display, for displaying player input icons for controlling the game and for generating signals upon the player touching displayed icons to control the game.

26. A method carried out by a gaming device comprising:
displaying a game to a player on a main display; and
receiving player inputs for controlling the game via a touch screen, the touch screen being separate from the main display.

27. The method of claim 26 further comprising controlling the touch screen to display virtual buttons.

28. The method of claim 26 further comprising allowing the player to select which virtual buttons to display on the touch screen.

29. The method of claim 26 further comprising allowing the player to select the location on the touch screen of at least one virtual button.

30. The method of claim 26 further comprising allowing the player to select a size of virtual buttons to display on the touch screen.

31. The method of claim 26 further comprising allowing the player to select a language identifying virtual buttons displayed on the touch screen.

32. The method of claim 26 further comprising automatically changing identities of virtual buttons displayed on the touch screen when the game is changed.

33. The method of claim 26 further comprising changing identities of virtual buttons displayed on the touch screen to only display buttons that a player can use for a present game.

34. The method of claim 26 further comprising highlighting certain virtual buttons displayed on the touch screen.

35. The method of claim 26 further comprising displaying a message on the touch screen to convey information about modifying virtual buttons displayed on the touch screen.

36. The method of claim 26 further comprising granting an award to a player for a winning outcome of the game.

37. The method of claim 26 further comprising automatically changing identities of virtual buttons displayed on the touch screen when the game is changed to a bonus game after a certain outcome of a main game.

38. The method of claim 26 further comprising receiving player inputs for controlling the game via a joystick.

39. The method of claim 26 further comprising receiving player inputs for controlling the game via physical buttons.

40. A method performed by a gaming machine comprising:
receiving currency in the form of one or more bills by a player inserting the one or more bills into the gaming machine;
granting credits to the player after receiving the one or more bills, each credit representing a monetary value for wagering, each bill inserted into the gaming machine below a certain value generating credits equal to the monetary value of the bill, each bill inserted into the gaming machine at or above the certain value generating credits equal to the monetary value of the bill plus at least one extra credit; and
carrying out a game pursuant to the player wagering one or more of the credits for playing the game.

41. The method of claim 40 wherein the certain amount is one hundred dollars.

42. The method of claim 40 wherein the at least one extra credit comprises at least five extra credits for inserting a one hundred dollar bill.

43. The method of claim 40 further comprising preventing the player from cashing out of the gaming machine after receiving the at least one extra credit until the player has wagered a certain amount.

44. The method of claim 40 wherein inserting a bill of a first value generates a first number of extra credits and inserting a bill of a value greater than the first value generates a number of extra credits greater than the first number of extra credits.

45. A gaming machine comprising:
a display for displaying a game;
a monetary input device, wherein money provided to the monetary input device generates credits in the gaming machine for playing the game; and
a player-controlled element for allowing the player to select the value of a single credit for wagering in the game.

46. The machine of claim 45 wherein the player-controlled element allows the player to choose the value of a credit as being any one of $1, 25¢, and 5¢.

47. The machine of claim 45 wherein the player-controlled element comprises a button.

48. The machine of claim 45 wherein the player-controlled element comprises a virtual button on a touch screen.

49. The machine of claim 45 wherein the value of a single credit for wagering in the game may be selected by the player to be one of at least a first denomination and a second denomination, the second denomination being greater than the first denomination, wherein the monetary input device comprises a bill acceptor for receiving a bill of at least a first value, the gaming machine further comprising processing circuitry for generating credits equal to the monetary value of the bill, the processing circuitry also generating one or more additional credits after receiving the bill if the second denomination is selected by the player.

50. A method performed by a gaming machine comprising:
receiving money in a monetary input device;
generating credits in the gaming machine for playing a game in response to receiving money;
receiving a signal from a player-controlled element identifying a player-selected value of a single credit for wagering in the game;
generating a signal identifying a number of credits wagered for a game;
displaying a game; and
awarding one or more credits for a winning outcome of the game.

51. The method of claim 50 wherein the player-controlled element allows the player to choose the value of a credit as being any one of $1, 25¢, and 5¢.

52. The method of claim 50 wherein the player-controlled element comprises a button.

53. The method of claim 50 wherein the player-controlled element comprises a virtual button on a touch screen.

54. The method of claim 50 wherein the value of a single credit for wagering in the game may be selected by the player to be one of at least a first denomination and a second denomination, the second denomination being greater than the first denomination, wherein the monetary input device comprises a bill acceptor for receiving a bill of at least a first value, the method further comprising generating credits equal to the monetary value of the bill and generating one or more additional credits after receiving the bill if the second denomination is selected by the player.
